(19) United States
(12) Patent Application Publication
(10) Pub. No.: US 2015/0159877 A1
(43) Pub. Date: Jun. 11, 2015

(54) LATE LEAN INJECTION MANIFOLD MIXING SYSTEM

(71) Applicant: General Electric Company, Schenectady, NY (US)

(72) Inventors: Lucas John Stoia, Taylors, SC (US); Patrick Benedict Melton, Horseshoe, NC (US); Ronnie Ray Pentecost, Travelers Rest, SC (US); William Francis Carnell, JR., Greer, SC (US)

(73) Assignee: General Electric Company, Schenectady, NY (US)

(21) Appl. No.: 14/099,515

(22) Filed: Dec. 6, 2013

(51) Int. Cl. F23R 3/34; F02C 7/22

(52) U.S. Cl. CPC F23R 3/346; F02C 7/22; F05D 2240/36

(57) ABSTRACT

A manifold mixing system for combustor of a gas turbine engine includes a fuel supply, a fuel injector coupled with the fuel supply, and a manifold mixer cooperable with the fuel injector and including mixing air inlets. The fuel injector is displaceable relative to the manifold mixer while being positioned to deliver fuel from the fuel supply to the manifold mixer. The manifold mixer is shaped to mix the fuel from the fuel supply with air input via the mixing air inlets for injection into the combustor.

### BACKGROUND OF THE INVENTION

The present invention relates to gas turbine engines, and more particularly, to a late lean injection manifold mixing system to inject a premixed fuel/air mixture into a combustion zone downstream of a primary combustion zone for a can-annular gas turbine combustor.

Multiple designs exist for staged combustion in combustion turbine engines, but most are complicated assemblies consisting of a plurality of tubing and interfaces. One kind of staged combustion used in combustion turbine engines is late lean injection. In this type of staged combustion, late lean fuel injectors are located downstream of the primary fuel injector. Combusting a fuel/air mixture at this downstream location may be used to improve NOx performance. NOx, or oxides of nitrogen, is one of the primary undesirable air polluting emissions produced by gas turbine engines that burn conventional hydrocarbon fuels.

Current late lean injection assemblies are expensive and costly for both new gas turbine units and retrofits of existing units. One of the reasons for this is the complexity of conventional late lean injection systems, particularly those systems associated with the fuel delivery. The many parts associated with these complex systems must be designed to withstand the extreme thermal and mechanical loads of the turbine environment, which significantly increases manufacturing expense. Even so, conventional late lean injection assemblies still have a high risk for fuel leakage into the compressor discharge casing, which can result in auto-ignition and be a safety hazard.

Gas fuel is typically transmitted from a supply manifold to the combustor injector using a tube assembly.

The injectors are typically connected with the combustor sleeve, while the fuel line may be connected to a different component of the combustor such as the mounting flange. A bellows may be used to accommodate thermal excursions during start-up and shut down. These separate sub-assemblies need to move relative to each other in operation. The components, however, are installed as a module, and it is undesirable for the sub-assemblies to move relative to each other during installation, which could result in damage to the bellows. Assembly thus requires an elaborate assembly tool, which must be used properly and requires operator experience. Moreover, gas fuel is transmitted from the supply manifold to the combustor injector using a tube assembly. When the gas turbine is fired, the relative thermal displacements between the supply manifold and the injector can create undesirable strains in the tube.

### BRIEF DESCRIPTION OF THE INVENTION

In an exemplary embodiment, a manifold mixing system for combustor of a gas turbine engine includes a fuel supply, a fuel injector coupled with the fuel supply, and a manifold mixer cooperable with the fuel injector and including mixing air inlets. The fuel injector is displaceable relative to the manifold mixer while being positioned to deliver fuel from the fuel supply to the manifold mixer. The manifold mixer is shaped to mix the fuel from the fuel supply with air input via the mixing air inlets for injection into the combustor.

In another exemplary embodiment, a combustor for a gas turbine engine includes a combustion chamber including a primary combustion zone downstream of a fuel nozzle and a liner and flowsleeve assembly delimiting the combustion chamber. A manifold mixing system is coupled between a combustor mounting flange and the liner and flowsleeve assembly and delivers pre-mixed fuel and air downstream of the primary combustion zone.

### BRIEF DESCRIPTION OF THE DRAWINGS

FIG. 1 shows a typical combustion turbine system;

FIG. 2 is a section view of a conventional combustor;

FIG. 3 is a perspective view showing the manifold mixing system;

FIG. 4 is a close-up view of the interface between the fuel injector and the manifold mixer;

FIG. 5 is a side view of the manifold mixing system; and

FIG. 6 is a schematic cross-sectional view of the manifold mixing system.

### DETAILED DESCRIPTION OF THE INVENTION

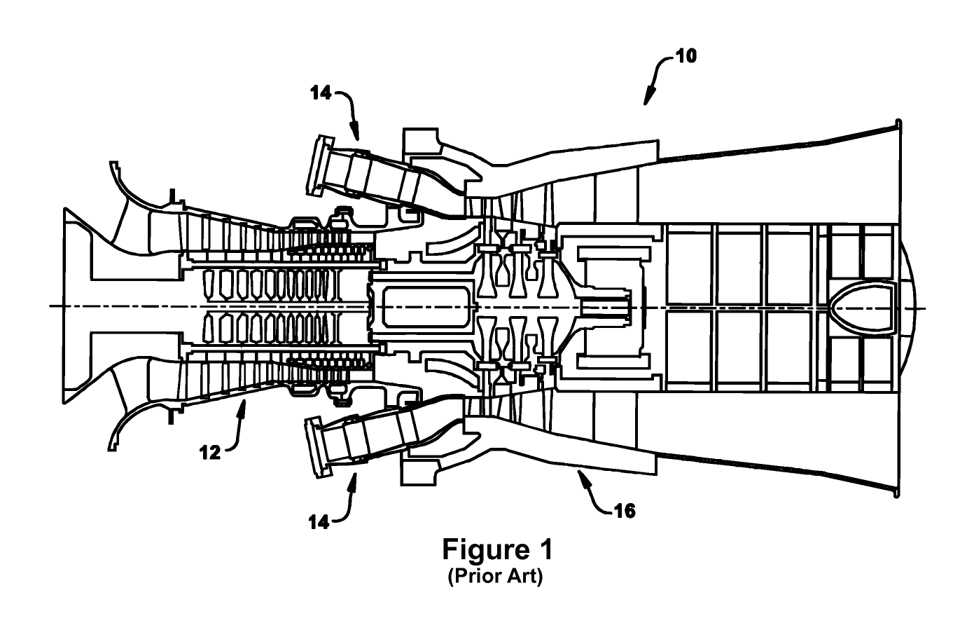

FIG. 1 is an illustration showing a typical combustion turbine system 10. The gas turbine system 10 includes a compressor 12, which compresses incoming air to create a supply of compressed air, a combustor 14, which burns fuel so as to produce a high-pressure, high-velocity hot gas, and a turbine 16, which extracts energy from the high-pressure, high-velocity hot gas entering the turbine 16 from the combustor 14 using turbine blades, so as to be rotated by the hot gas. As the turbine 16 is rotated, a shaft connected to the turbine 16 is caused to be rotated as well, the rotation of which may be used to drive a load. Finally, exhaust gas exits the turbine 16.

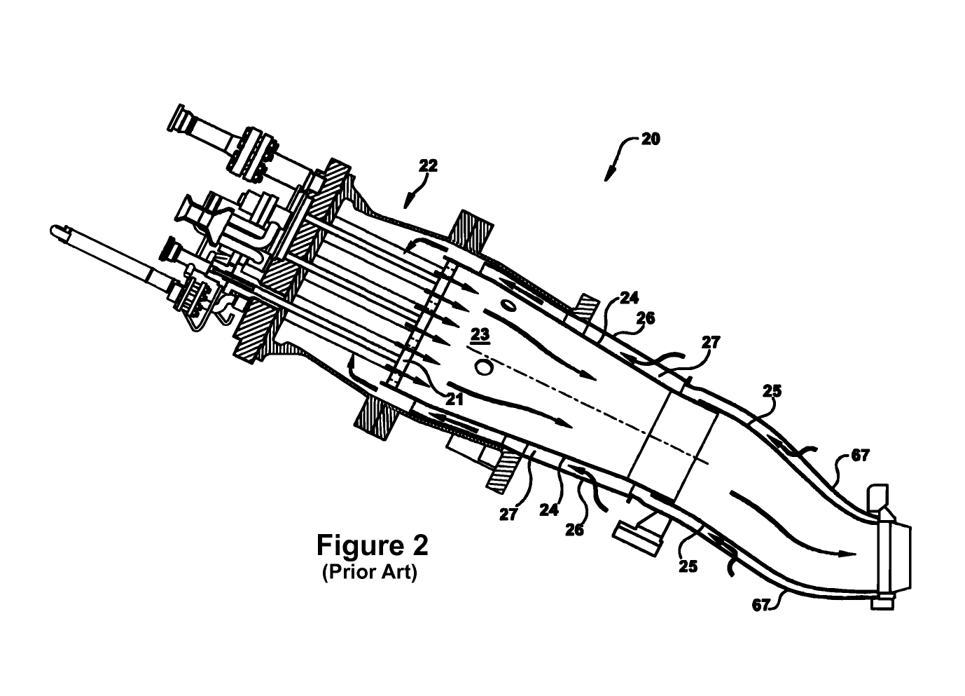

FIG. 2 is a section view of a conventional combustor in which embodiments of the present invention may be used. Though the combustor 20 may take various forms, each of which being suitable for including various embodiments of the present invention, typically, the combustor 20 includes a head end 22, which includes multiple fuel nozzles 21 that bring together a flow of fuel from a fuel supply and air for combustion within a primary combustion zone 23, which is defined by a surrounding liner 24. The liner 24 typically extends from the head end 22 to a transition piece 25. The liner 24, as shown, is surrounded by a flow sleeve 26. The transition piece 25 is surrounded by an impingement sleeve 67. Between the flow sleeve 26 and the liner 24 and the transition piece 25 and impingement sleeve 67, it will be appreciated that an annulus, which will be referred to herein as a “flow annulus 27,” is formed. The flow annulus 27, as shown, extends for a most of the length of the combustor 20. From the liner 24, the transition piece 25 transitions the flow from the circular cross section of the liner 24 to an annular cross section as it travels downstream to the turbine section (not shown). At a downstream end, the transition piece 25 directs the flow of the working fluid toward the airfoils that are positioned in the first stage of the turbine 16.

It will be appreciated that the flow sleeve 26 and impingement sleeve 27 typically have impingement apertures (not shown) formed therethrough which allow an impinged flow of compressed air from the compressor 12 to enter the flow annulus 27 formed between the flow sleeve 26/liner 24 and/or the impingement sleeve 67/transition piece 25. The flow of compressed air through the impingement apertures convectively cools the exterior surfaces of the liner 24 and transition piece 25. The compressed air entering the combustor 20 through the flow sleeve 26 is directed toward the forward end of the combustor 20 via the flow annulus 27 formed about the liner 24. The compressed air then may enter the fuel nozzles 21, where it is mixed with a fuel for combustion within the combustion zone 23.

As noted above, the turbine 16 includes turbine blades, into which products of the combustion of the fuel in the liner 24 are received to power a rotation of the turbine blades. The transition piece directs the flow of combustion products into the turbine 16, where it interacts with the blades to induce rotation about the shaft, which, as stated, then may be used to drive a load, such as a generator. Thus, the transition piece 25 serves to couple the combustor 20 and the turbine 16. In systems that include late lean injection, it will be appreciated that the transition piece 25 also may define a secondary combustion zone in which additional fuel supplied thereto and the products of the combustion of the fuel supplied to the liner 24 combustion zone are combusted.

As used herein, a “late lean injection system” is a system for injecting a mixture of fuel and air into the flow of working fluid at any point that is downstream of the primary fuel nozzles 21 and upstream of the turbine 16. In certain embodiments, a “late lean injection system 28” is more specifically defined as a system for injecting a fuel/air mixture into the aft end of the primary combustion chamber defined by the liner. In general, one of the objectives of late lean injection systems includes enabling fuel combustion that occurs downstream of primary combustors/primary combustion zone. This type of operation may be used to improve NOx performance, however, as one of ordinary skill in the relevant art will appreciate, combustion that occurs too far downstream may result in undesirable higher CO emissions. As described in more detail below, the present invention provides effective alternatives for achieving improved NOx emissions, while avoiding undesirable results.

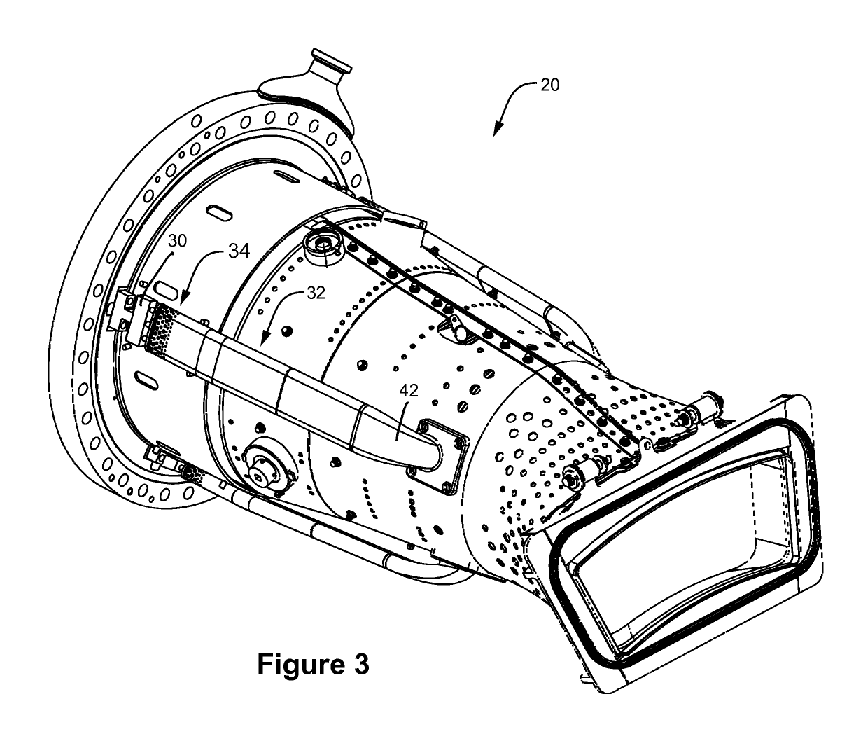

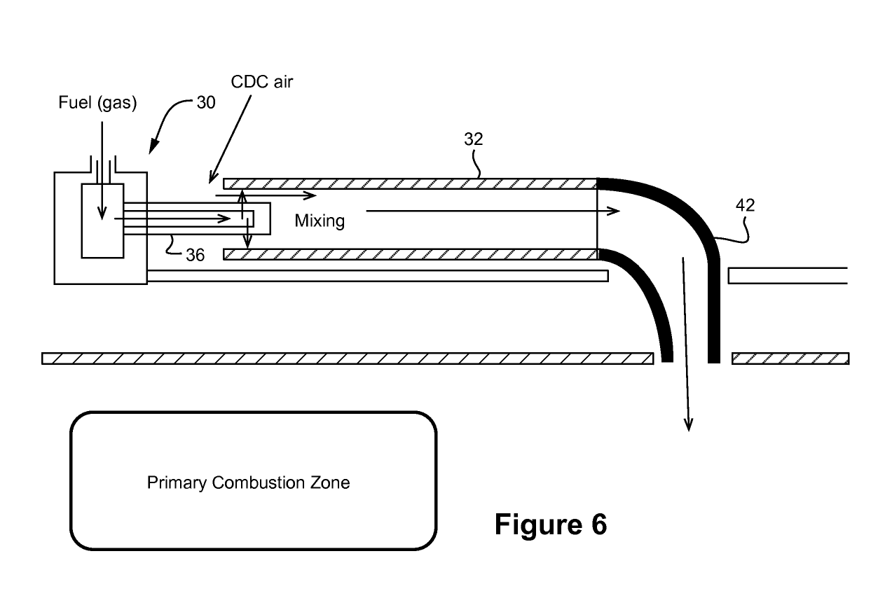

With reference to FIGS. 3-6, a manifold mixing system of the preferred embodiment includes a fuel injector 30 coupled with the fuel supply and a manifold mixer 32 cooperable with the fuel injector and including mixing air inlets 34 formed around a perimeter of the manifold mixer 32. In one construction, the mixing air inlets 34 are oriented toward a center of the manifold mixer 32, which creates turbulence for better mixing and also better prevents flame holding. The holes allow air from the combustion discharge casing (CDC) to enter for mixing with fuel from the injectors.

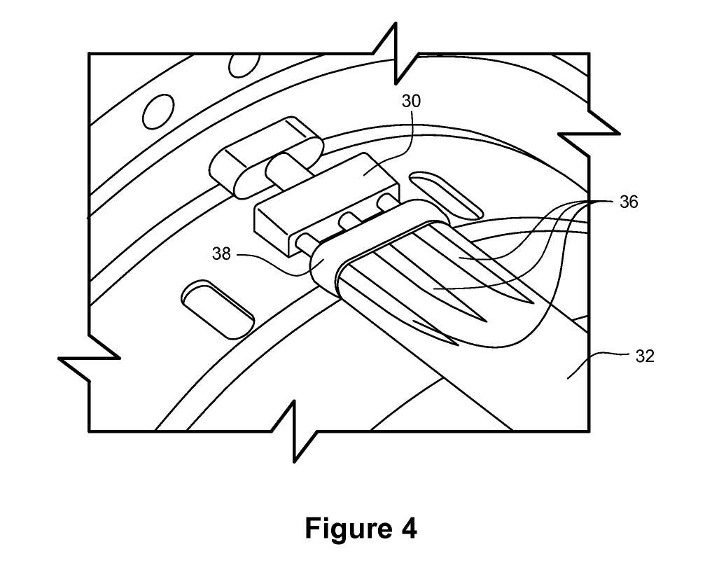

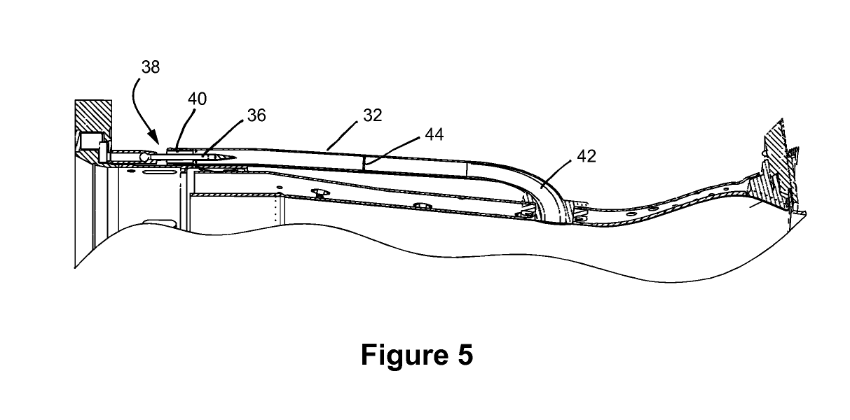

The fuel injector 30 includes one or more spike components 36 (three shown in FIG. 4) positionable inside the manifold mixer 32. The spike components 36 are mounted to the LLI (late lean injection) flange. The manifold mixer 32 includes an end cap 38 secured to an upstream end thereof, wherein the one or more spike components 36 extend through corresponding openings in the end cap 38. In a preferred construction, the end cap 38 includes a shroud 40 (FIG. 5) that surrounds the spike component(s) 36. As shown in FIG. 3, at least some of the mixing air inlets 34 are positioned upstream of an end of the spike component(s) 36.

With continued reference to FIGS. 3 and 5, the manifold mixer 32 is preferably shaped such that a radial height of the manifold mixer 32 is less than a circumferential width of the manifold mixer. The radial height is shown in the sectional view of FIG. 5, and the circumferential width is shown in the perspective view of FIG. 3. Preferably, the manifold mixer 32 is formed into a curved oblong shape and includes a transition 42 at a downstream end thereof. The transition 42 is shaped to turn the fuel and air in the manifold mixer 32 from an axial mixing direction to a radial injection direction through the wall of the combustion sleeve. As shown, at least a portion of the transition may be cylindrical, e.g., at the combustion sleeve wall. Other shapes may be suitable. The geometry of the transition 42 enables the air/fuel mixture to make the radial turn without separation. The smooth transition facilitates this result with low pressure gradients.

The manifold mixer 32 may additionally include a ring of surface air inlet holes 44 substantially midway between ends of the manifold mixer. The surface air inlet holes 44 are oriented at a shallow angle to create a film of air on the manifold interior surface. The film of air keeps the fuel/air profile lean on the outside diameter of the manifold mixer 32. The air film surrounds the air/fuel mixture and further prevents the production of NOx emissions. At the transition 42, the film of air further mixes with the air/fuel mixture.

The length of the manifold mixer 32 in the configuration of the preferred embodiment is considerably longer than prior art mixing zones. NOx emissions are more effectively controllable when the fuel and air are highly pre-mixed before injection. The short lengths of existing systems require mixing in as little as two inches whereas the present design provides for mixing over a much greater distance, such as two feet or more.

The manifold mixing system injects a premixed fuel/air mixture into the combustion zone downstream of the primary combustion zone for a can-annular gas turbine combustor. The manifold mixer is preferably located outside a flow sleeve/unisleeve and extends aft to a combustor liner/unibody/transition piece injection point downstream of the primary combustion zone. The manifold mixer is attached or is transitioned to a late lean injector that turns the flow into the combustion zone as it passes through the flow sleeve/unisleeve and liner/unibody. The fuel injector and manifold mixer do not require a leak detection system, and the design is more robust and simpler than previous designs. The assembly also provides better premixing of the fuel/air mixture before being injected into the combustor. The structure provides for a combustor with better reliability, better emissions, and lower overall gas turbine cost.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A manifold mixing system for combustor of a gas turbine engine, the manifold mixing system comprising:
a fuel supply;
a fuel injector coupled with the fuel supply; and
a manifold mixer cooperable with the fuel injector and including mixing air inlets,
wherein the fuel injector is displaceable relative to the manifold mixer while being positioned to deliver fuel from the fuel supply to the manifold mixer, and wherein the manifold mixer is shaped to mix the fuel from the fuel supply with air input via the mixing air inlets for injection into the combustor.

2. A manifold mixing system according to claim 1, wherein the fuel injector comprises a spike component disposed inside the manifold mixer.

3. A manifold mixing system according to claim 2, comprising a plurality of spike components disposed inside the manifold mixer.

4. A manifold mixing system according to claim 2, wherein the manifold mixer comprises an end cap secured to an upstream end thereof, and wherein the spike component extends through an opening in the end cap.

5. A manifold mixing system according to claim 4, wherein the end cap comprises a shroud that surrounds the spike component.

6. A manifold mixing system according to claim 2, wherein at least some of the mixing air inlets are positioned upstream of an end of the spike component.

7. A manifold mixing system according to claim 1, wherein the mixing air inlets are formed around a perimeter of the manifold mixer.

8. A manifold mixing system according to claim 1, wherein the manifold mixer is shaped such that a radial height of the manifold mixer is less than a circumferential width of the manifold mixer.

9. A manifold mixing system according to claim 8, wherein the manifold mixer comprises a curved oblong shape.

10. A manifold mixing system according to claim 9, wherein the manifold mixer comprises a transition at a downstream end thereof, the transition being shaped to turn the fuel and air in the manifold mixer from an axial mixing direction to a radial injection direction.

11. A manifold mixing system according to claim 10, wherein at least a portion of the transition is cylindrical.

12. A manifold mixing system according to claim 1, wherein the manifold mixer comprises a ring of surface air inlet holes substantially midway between ends of the manifold mixer.

13. A combustor for a gas turbine engine, the combustor comprising:
a combustion chamber including a primary combustion zone downstream of a fuel nozzle;
a liner and flowsleeve assembly delimiting the combustion chamber;
a manifold mixing system coupled between a combustor mounting flange and the liner and flowsleeve assembly, the manifold mixing system delivering pre-mixed fuel and air downstream of the primary combustion zone, the manifold mixing system comprising:
a fuel supply;
a fuel injector coupled with the fuel supply; and
a manifold mixer cooperable with the fuel injector and including mixing air inlets,
wherein the fuel injector is displaceable relative to the manifold mixer while being positioned to deliver fuel from the fuel supply to the manifold mixer, and wherein the manifold mixer is shaped to mix the fuel from the fuel supply with air input via the mixing air inlets for injection into the combustor.

14. A combustor according to claim 13, wherein the manifold mixer is shaped such that a radial height of the manifold mixer is less than a circumferential width of the manifold mixer.

15. A combustor according to claim 14, wherein the manifold mixer comprises a curved oblong shape.

16. A combustor according to claim 15, wherein the manifold mixer comprises a transition at a downstream end thereof extending through the liner and flowsleeve assembly, the transition being shaped to turn the fuel and air in the manifold mixer from an axial mixing direction to a radial injection direction for injection into the combustor downstream of the primary combustion zone.

17. A combustor according to claim 16, wherein at least a portion of the transition is cylindrical.

18. A combustor according to claim 13, wherein the fuel injector comprises a spike component disposed inside the manifold mixer.

19. A combustor according to claim 18, comprising a plurality of spike components disposed inside the manifold mixer.
